(19) United States
(12) Patent Application Publication
(10) Pub. No.: US 2006/0026245 A1
(43) Pub. Date: Feb. 2, 2006

(54) System and method for data organization and display in an instant-messaging interface

(76) Inventors: Ivy Cunningham, Seattle, WA (US); Stacia Lynn Pache, Redmond, WA (US); David Brudnicki, Duvall, WA (US)

Correspondence Address: DOCKET CLERK, P.O. BOX 802432, DALLAS, TX, 75380, US

(21) Appl. No.: 10/933,677

(22) Filed: Sep. 3, 2004

Related U.S. Application Data
(60) Provisional application No. 60/585,965, filed on Jul. 7, 2004.
(60) Provisional application No. 60/590,229, filed on Jul. 21, 2004.
(60) Provisional application No. 60/588,018, filed on Jul. 12, 2004.
(60) Provisional application No. 60/588,307, filed on Jul. 15, 2004.
(60) Provisional application No. 60/588,110, filed on Jul. 15, 2004.
(60) Provisional application No. 60/590,185, filed on Jul. 21, 2004.
(60) Provisional application No. 60/587,792, filed on Jul. 12, 2004.

(51) Int. Cl. G06F 15/16

(52) U.S. Cl. 709/206

(57) ABSTRACT

A system, method, and computer program product for simultaneous integrated access to multiple instant messaging (IM) servers from multiple IM vendors. A particular feature of many specific embodiments is a user interface that maintains separate, distinct branding for each vendor, so that a user of the system can see other user names, functions, and other vendor-specific features as clearly associated with a particular IM vendor.

### CROSS-REFERENCE TO RELATED APPLICATIONS

The present application claims the benefit of the filing dates of the following U.S. Provisional Patent Applications, all of which are hereby incorporated by reference: provisional application 60/585,965, filed 7 Jul. 2004, for “System and Method for Data Organization and Display in an Instant-Messaging Interface”, provisional application 60/590,229, filed 21 Jul. 2004, for “Always-On Mobile Instant Messaging of a Messaging Centric Wireless Device”, provisional application 60/588,018, filed 11 Jul. 2004, for “Maintaining Instant Message Session Status in Dynamic Operating Environments”, provisional application 60/588,307, filed 15 Jul. 2004, for “Using Emoticons, Such as for Wireless Devices”, provisional application 60/588,110, filed 15 Jul. 2004, for “Customer Service Messaging, Such as on Mobile Devices”, provisional application 60/590,185, filed 21 Jul. 2004, for “Dedicated Wireless Device Business Method”, and provisional application 60/587,792, filed 11 Jul. 2004, for “Selection of Bearer Mode According to Message Characteristics.”

### TECHNICAL FIELD OF THE INVENTION

The present invention is directed, in general, to computer-implemented messaging systems.

### BACKGROUND OF THE INVENTION

Instant messaging (IM) systems on desktop computer systems have become common and well known in the art. These systems allow users to communicate with each other in a real-time fashion, as well as to see whether other users are active, exchange files with each other, and perform other tasks. IM systems are managed by an IM server, that maintains the status of each user and facilitates communications between them.

Multiple vendors provide IM server systems, each typically using a unique connection protocol, and requiring that each user maintain a userid on that vendor's system. Some well-known vendors include MSN Messenger, ICQ, Yahoo! Instant Messenger, and AOL Instant Messenger. Typically a userid on one vendor's system cannot communicate with other vendors' IM servers, nor with the users of the other servers. Because any given individual may only have an account on one specific vendor's IM server, to communicate with that individual, others must use that vendor's IM server as well.

As a result, many individuals maintain accounts and userids on multiple vendor systems, in order to be abler to communicate with other users on each respective system. Since each vendor typically provides its own interface and software, the user must run server IM clients concurrently in order to simultaneously connect to multiple vendors' IM servers. This is inefficient, requiring the individual to learn multiple interfaces and to clutter his desktop or other system with them. On other systems, such as mobile devices, this is not even possible since these devices don't support multitasking.

There is, therefore, a need in the art for a system, method, and computer program product for integrated access to multiple IM servers from multiple IM vendors.

### SUMMARY OF THE INVENTION

The present invention overcomes the limitations of the prior art and provides additional benefits. A brief summary of some embodiments and aspects of the invention are first presented. Some simplifications and omissions may be made in the following summary. The summary is intended to highlight and introduce some aspects of the disclosed embodiments, but not to limit the scope of the invention. The summary does not provide an exhaustive list of embodiments of the invention.

A detailed description of illustrated embodiments is presented after the summary. The detailed description will permit one skilled in the relevant art to make and use aspects of the invention. One skilled in the relevant art can obtain a full appreciation of aspects of the invention from the subsequent detailed description, read together with the Figures, and from the claims (which follow the detailed description).

A preferred embodiment provides a system, method, and computer program product for simultaneous integrated access to multiple instant messaging (IM) servers from multiple IM vendors. A particular feature of many specific embodiments is a user interface that maintains separate, distinct branding for each vendor, so that a user of the system can see other user names, functions, and other vendor-specific features as clearly associated with a particular IM vendor.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts an exemplary screenshot of a system in accordance with a preferred embodiment; and

FIG. 2 depicts an exemplary screenshot of a system in accordance with a preferred embodiment.

In the drawings, the same reference numbers and acronyms identify elements or acts with the same or similar functionality for ease of understanding and convenience. To easily identify the discussion of any particular element or act, the most significant digit or digits in a reference number refer to the Figure number in which that element is first introduced (e.g., element 1104 is first introduced and discussed with respect to FIG. 11).

Figure numbers followed by the letters “A,” “B,” “C,” etc. indicate either (1) that two or more Figures together form a complete Figure (e.g., FIGS. 10A and 10B together form a single, complete FIG. 10), but are split between two or more Figures because of paper size restrictions, amount of viewable area within a computer screen window, etc., or (2) that two or more Figures represent alternative embodiments or methods under aspects of the invention.

### DETAILED DESCRIPTION OF THE INVENTION

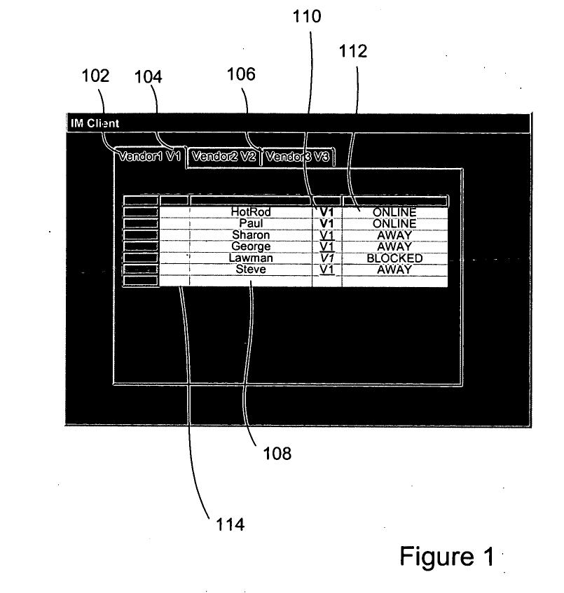

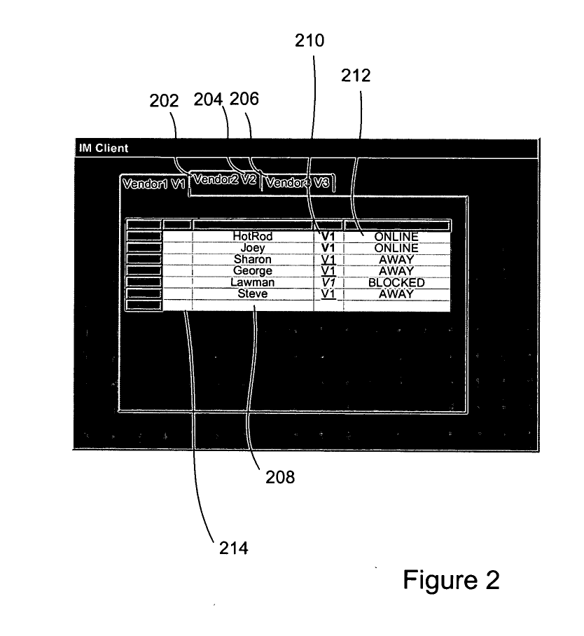

FIGS. 1 through 2 , discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention.

Definitions: In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions.

A preferred embodiment provides a system, method, and computer program product for simultaneous integrated access to multiple instant messaging (IM) servers from multiple IM vendors. A particular feature of many specific embodiments is a user interface that maintains separate, distinct branding for each vendor, so that a user of the system can see other user names, functions, and other vendor-specific features as clearly associated with a particular IM vendor. This approach maintains each vendor's branding, instead of aggregating usernames, functions, etc., together in the interface so that vendor branding is lost.

Typically, in IM systems, the users for a specific vendor, and the other features or functions available for that vendor, are referred to as an IM “community.” Each vendor's community has a term for referring to other, specifically-identified users of that vendors system. For example, AOL Instant Messenger (AIM) uses the term “Buddy”, MSN Messenger uses the term “IM Contact” or “Contact”, and Yahoo! Instant Messaging uses the term “Friend.” As used herein, and unless specifically noted with regard to a particular vender, the term “buddy” will be used to generically refer to these other users.

Specific embodiments described herein relate to an IM aggregator system and software for execution on a wireless device such as a mobile telephone, PDA, or “smartphone.” Those of skill in the art will recognize that the system and method described and claimed is also applicable to desktop and laptop computer systems, as well as other systems capable of IM communications.

FIGS. 1 and 2 each depict an IM Folders screen, in a preferred embodiment, which shows community buddies lists and Status. Each of these figures has a different community “tab” selected, showing the buddies and icons associated with a respective vendor. Also displayed is an active or new received Chat indication and corresponding icon.

In FIG. 1, active tab 102 is shown, indicating that it corresponds to the “Vendor1” community. Each tab also has an icon 104 corresponding to the vendor's branding, shown here in simplified form as V1, V2, and V3, corresponding to Vendor1, Vendor2, and Vendor3. In the preferred embodiment, both the label for each vendor and the associated icon 104 corresponds exactly to that vendor's branding strategy.

Inactive tab 106 is similarly labeled, and illustrates that a separate folder for the Vendor3 community can be selected.

Within the IM folder for the Vendor1 community, multiple buddies 108 are shown, listed in a column. Each buddy 108 is shown associated with a status/presence icon 110, which preferably corresponds to Vendor1's icon/branding strategy. Status indicators 112 give a text status for each buddy 108. Column 114, shown empty here, can be used for assigning a specific, user-customizable icon to each buddy.

FIG. 2 is similar to FIG. 1, showing a different active tab. In FIG. 2, active tab 202 is shown, indicating that it corresponds to the “Vendor2” community. Each tab also has an icon 204 corresponding to the vendor's branding, shown here in simplified form as V1, V2, and V3, corresponding to Vendor1, Vendor2, and Vendor3. In the preferred embodiment, both the label for each vendor and the associated icon 204 corresponds exactly to that vendor's branding strategy.

Inactive tab 206 is similarly labeled, and illustrates that a separate folder for the Vendor3 community can be selected.

Within the IM folder for the Vendor2 community, multiple buddies 208 are shown, listed in a column. Each buddy 208 is shown associated with a status/presence icon 210, which preferably corresponds to Vendor2's icon/branding strategy. Status indicators 212 give a text status for each buddy 208. Column 214, shown empty here, can be used for assigning a specific, user-customizable icon to each buddy.

Here, each vendor community has a specific tab, and each tab is labeled with that vendor's brand. Within the IM Folder for each tab, the icons used for user identification, status identification, and otherwise are preferably consistent with that vendor's branding. A preferred embodiment provides up to 3 folder tabs, one for each supported community Buddy list. Community Buddy List tabs are only presented if the user has previously registered to the service. Each tab displays the community's name and icon. Of course, in other embodiments, more or less folder tabs can be implemented and shown.

In use, pressing Enter on a highlighted Buddy invokes the corresponding community Chat screen. Via Option Menu, the user may add/remove Buddies, and view/edit/Link to the Buddy's Contact Profile, or Block and Un-Block the Buddy.

Community Default Alerticons—Each of the 3 IM communities have a “Branded” default Alerticon that may (or may not) be assigned to a Buddy. Note that IM Community Default Alerticons can incorporate animation and audio, and be used as Banner Alerts for new received IM text.

When the user first imports the Buddy from a vendor's IM server, the corresponding Community vendor-branded Alerticon is automatically assigned to the Buddy. If the user desires, they may create a link between a buddy in one community and a buddy in another community, and via access to a contact profile change the IM Community Default Alerticon to an alternate selection. In one embodiment, a buddy that only linked or associated with one community can not change the community default Alerticon.

Upon creating a link between a buddy in one community and a buddy in another community, the Alerticon will be changed to whatever Alerticon is assigned to the buddy at the time of creating the Link.

Upon creating a new buddy, the buddy's IM name is displayed as imported from the specific vendor/community IM server. Community-specific presence icons and icon behavior is to conform to each vendor's standards. That is, an icon indicating the status or presence of a buddy will be shown using the vendor's specific icons, according to the community being viewed.

A community-specific “chat” icon will appear at the right most position of the line if a Chat—an active IM dialogue—is open between the user and the respective buddy. In a preferred embodiment, this icon will continuously animate if any unread Chat text was received. This icon becomes static after the Chat is opened to read the new Chat text, and the user then exits the Chat screen.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links. Aspects of the invention described above may be stored or distributed on computer-readable media, including magnetic and optically readable and removable computer discs, as well as distributed electronically over the Internet or over other networks (including wireless networks). Those skilled in the relevant art will recognize that portions or embodiments of the invention may reside in a fixed element of a communication network, while corresponding portions may reside on a mobile communication device. Data structures and transmission of data particular to aspects of the invention are also encompassed within the scope of the invention.

According to one embodiment of the present invention, there is provided a method for providing a user interface to an instant-messaging client, comprising displaying, in an instant-messaging interface, a plurality of vendor icons representing instant-messaging service vendors; and displaying, in an instant-messaging interface, a plurality of user icons representing users of the instant-messaging service vendors, wherein each of the user icons and vendor icons correspond to an icon set defined by the respective instant-messaging service vendor. According to another embodiment of the present invention, there is provided a computer program product tangibly embodied in a machine-readable medium, comprising instructions for displaying, in an instant-messaging interface, a plurality of vendor icons representing instant-messaging service vendors; and instructions for displaying, in an instant-messaging interface, a plurality of user icons representing users of the instant-messaging service vendors, wherein each of the user icons and vendor icons correspond to an icon set defined by the respective instant-messaging service vendor. According to another embodiment of the present invention, there is provided a consumer device including an instant-messaging application, comprising means for displaying, in an instant-messaging interface, a plurality of vendor icons representing instant-messaging service vendors; and means for displaying, in an instant-messaging interface, a plurality of user icons representing users of the instant-messaging service vendors, wherein each of the user icons and vendor icons correspond to an icon set defined by the respective instant-messaging service vendor.

Although an exemplary embodiment of the present invention has been described in detail, those skilled in the art will understand that various changes, substitutions, variations, and improvements of the invention disclosed herein may be made without departing from the spirit and scope of the invention in its broadest form. Although embodiments of the invention have been described primarily in the context of wireless networks, the teachings of the invention provided herein can be applied to many other types of networks and network operators. Embodiments of the invention could be applied to any sort of network where the network operator must off-load some traffic onto another operator's network. For example, those skilled in the art could apply the teachings of the invention to an Internet Service Provider (ISP) network. The preferred embodiment is based on a datagram method, such as Internet Protocol (I.P.), including bearer networks such as wireless (GPRS, EDGE, UMTS, CDMA, etc.), WiFi, LAN/WAN, and data over voice channels (Circuit-switched data), among others. These and other changes can be made to the invention in light of the detailed description.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC § 112 unless the exact words “means for” are followed by a participle.

What is claimed is:

1. A method for providing a user interface to an instant-messaging client, comprising:
displaying, in an instant-messaging interface, a plurality of vendor icons representing instant-messaging service vendors; and
displaying, in an instant-messaging interface, a plurality of user icons representing users of the instant-messaging service vendors,
wherein each of the user icons and vendor icons correspond to an icon set defined by the respective instant-messaging service vendor.

2. The method of claim 1, wherein the user icons corresponding to each instant-messaging service vendor are displayed in a separate icon list.

3. The method of claim 1, wherein the user icons corresponding to each instant-messaging service vendor are displayed in a separate selectable display area.

4. The method of claim 1, wherein the user icons corresponding to each instant-messaging service vendor can be selected using a graphical user interface tab selection.

5. The method of claim 1, wherein the user icons indicate the status of the user.

6. The method of claim 1, wherein the instant-messaging service vendors can be identified from the user icons and the vendor icons.

7. A computer program product tangibly embodied in a machine-readable medium, comprising:
instructions for displaying, in an instant-messaging interface, a plurality of vendor icons representing instant-messaging service vendors; and
instructions for displaying, in an instant-messaging interface, a plurality of user icons representing users of the instant-messaging service vendors,
wherein each of the user icons and vendor icons correspond to an icon set defined by the respective instant-messaging service vendor.

8. The computer program product of claim 7, wherein the user icons corresponding to each instant-messaging service vendor are displayed in a separate icon list.

9. The computer program product of claim 7, wherein the user icons corresponding to each instant-messaging service vendor are displayed in a separate selectable display area.

10. The computer program product of claim 7, wherein the user icons corresponding to each instant-messaging service vendor can be selected using a graphical user interface tab selection.

11. The computer program product of claim 7, wherein the user icons indicate the status of the user.

12. The computer program product of claim 7, wherein the instant-messaging service vendors can be identified from the user icons and the vendor icons.

13. A consumer device including an instant-messaging application, comprising:
means for displaying, in an instant-messaging interface, a plurality of vendor icons representing instant-messaging service vendors; and
means for displaying, in an instant-messaging interface, a plurality of user icons representing users of the instant-messaging service vendors,
wherein each of the user icons and vendor icons correspond to an icon set defined by the respective instant-messaging service vendor.

14. The consumer device of claim 13, wherein the user icons corresponding to each instant-messaging service vendor are displayed in a separate icon list.

15. The consumer device of claim 13, wherein the user icons corresponding to each instant-messaging service vendor are displayed in a separate selectable display area.

16. The consumer device of claim 13, wherein the user icons corresponding to each instant-messaging service vendor can be selected using a graphical user interface tab selection.

17. The consumer device of claim 13, wherein the user icons indicate the status of the user.

18. The consumer device of claim 13, wherein the instant-messaging service vendors can be identified from the user icons and the vendor icons.

19. The consumer device of claim 13, wherein the consumer device is a wireless telephone.

20. The consumer device of claim 13, wherein the consumer device is a data processing system.
